(19) United States
(12) Patent Application Publication
(10) Pub. No.: US 2016/0139988 A1
(43) Pub. Date: May 19, 2016

(54) MEMORY UNIT

(71) Applicant: HEWLETT-PACKARD DEVELOPMENT COMPANY, L.P., Houston, TX (US)

(72) Inventors: Naveen Muralimanohar, Palo Alto, CA (US); Erik Ordentlich, Palo Alto, CA (US)

(73) Assignee: Hewlett-Packard Development Company, L.P., Houston, TX (US)

(21) Appl. No.: 14/898,539

(22) PCT Filed: Jul. 31, 2013
(86) PCT No.: PCT/US2013/052916

§ 371 Date: Dec. 15, 2015

(51) Int. Cl. G06F 11/10; G06F 3/06

(52) U.S. Cl. CPC G06F 11/1076; G06F 3/0619; G06F 3/0644; G06F 3/0683

(57) ABSTRACT

Operating a memory unit during a memory access operation. The memory unit includes a configuration of N data chips. A line of data stored in the memory unit is divided, with a controller, into a first portion and a second portion. The first portion of the line of data is encoded, with an outer code encoder, to generate an outer code output. The second portion of the line of data and the outer code output from the outer code encoder are encoded, with an inner code encoder, to generate an inner code output. A first layer of protection for the line of data is generated based on the inner code output and is stored to the memory unit, where the first layer of protection includes local error detection (LED) information combined with the line of data. A second layer of protection for the line of data is generated based on the first layer of protection and is stored to the memory unit. A decoding operation to retrieve the line of data is performing at the controller.

### CROSS-REFERENCE TO RELATED APPLICATIONS

This patent application is related to co-pending PCT Patent Application No. ______ (Attorney Docket No. 8327.25-14) and co-pending PCT Patent Application No. ______ (Attorney Docket No. 83273853), concurrently filed herewith.

### BACKGROUND

In modern, high-performance server systems that include complex processors and large storage devices, memory system reliability is a serious and growing concern. It is of critical importance that information in these systems is stored and retrieved without errors. When errors actually occur during memory access operations, it is also important that these errors are successfully detected and corrected.

### BRIEF DESCRIPTION OF THE DRAWINGS

FIG. 1 is a schematic illustration of an example of a system including a memory controller end a coding module.

FIG. 2 illustrates a schematic representation showing an example of a memory module.

FIG. 3 is a schematic illustration showing an example of a memory module rank.

FIG. 4 is a schematic illustration showing an example of a cache line.

FIG. 5 illustrates a flow chart showing an example of a method for operating a memory unit.

FIGS. 6A and 6B illustrate a flow chart showing an example of a method for decoding data received from a memory unit.

### DETAILED DESCRIPTION

A memory protection mechanism that provides better efficiency by offering a two-tier protection scheme that separates out error detection and error correction functionality is disclosed. The memory protection mechanism avoids one or more of the following: activation of a large number of memory chips during every memory access, increase in access granularity, and increase in storage overhead. The memory protection mechanism activates as few chips as possible on each memory access, conserves energy, leads to decreased dynamic random access memory (DRAM) access times, and improves system performance.

As described in additional detail below, the first layer of protection in the memory protection mechanism is beat error detection (LED), an immediate check that follows every access operation (i.e., read or write) to verify data fidelity. To ensure chip-level detection (required for chipkill-level reliability), LED information may be maintained per chip. In other words, LED information may not be associated with each cache line (also called a line of data) as a whole, but with every cache line “segment”, the fraction of the cache line present in a single chip in a rank of memory. In some examples, a relatively short checksum (e.g., 1's complement, Fletcher's sums, or other) computed over a cache line segment may be used as the error detection code and may be appended to the data. The LED information is attached to the data and a read request from the memory controller automatically sends the LED along with the data.

If the LED detects an error, the second layer of protection is then applied. The second layer of protection is the Global Error Correction (GEC), which may be stored in either the same row as the data segments or in a separate row that exclusively contains GEC information for several data rows. Unlike LED, the memory controller has to specifically request for GEC data of a detected failed cache line.

As further explained in additional detail below, the memory protection mechanism comprises a memory module that includes a reduced number of chips (e.g., DRAM chips). In one example, a rank of memory includes nine x8 chips and a burst of eight. Each memory operation may involve a cache line of 64 bytes. In the memory, data corresponding to one cache line is spread across all the chips in the rank. LED data and GEC data are also distributed among the chips in a rank. Because the system proposes a reduced number of chips, it increases the bits stored per chip for a cache line. Therefore, more redundancy on each chip is needed to protect the data in case of chip failure because the failure is likely to affect more bits. The required additional redundancy per chip must be in line with the specific data access granularities and the burst rate of the system.

In addition, because of the configuration of the described system, some failures in the memory may not be detected. Specifically, this may occur when the system uses simple parity and checksum to detect and recover from failures. Using checksum/parity cannot guarantee detection of any arbitrary set of failures across the data stored in all chips of the rank. It is possible that one in 2̂n failures may go undetected, where “n” is the number of checksum/parity bits in a single chip of the memory rank (i.e., in the described implementation they correspond to the LED bits). Therefore, in memory devices where random errors are likely, a simple checksum may not be sufficient to guarantee error free operations. Although most errors in DRAM include specific patterns and relate to a specific category, new sources of errors may arise in emerging technologies and may result in silent error corruption.

Therefore, the description proposes systems, methods, and computer readable media that improve detection and correction of random errors in a rank of memory and reduces the number of undetected error patterns. In some implementations, the description proposes a method of operating a memory unit during a memory access operation, where the memory unit includes a configuration of N data chips. The method includes dividing, with a controller, a line of data stored in the memory unit into a first portion and a second portion; encoding, with an outer code encoder, the first portion of the line of data to generate an outer code output; and encoding, with an inner code encoder, the second portion of the line of data and the outer code output from the outer code encoder to generate an inner code output. The method further includes generating and storing to the memory unit, with the controller, a first layer of protection for the line of data based on the inner code output. The first layer of protection includes local error detection (LED) information combined with the line of data. The method also includes generating and storing to the memory unit, with the controller, a second layer of protection for the line of data based on the first layer of protection; and performing, at the controller, a decoding operation to retrieve the line of data.

In other example implementations, the description proposes a system for operating a memory unit. The system includes a processor having a memory controller in communication with the memory unit. The memory controller is to perform an encoding operation based on a first memory access request. The encoding operation is to generate an outer code output using an outer code encoder of the controller to encode a first portion of a cache line, and generate an inner code output using an inner code encoder of the controller to encode a second portion of the cache line and the outer code output. The encoding operation is also to generate local error detection (LED) data for the cache line based on the inner code output, and generate global error correction (GEC) data for the cache line based on the LED data. The LED data and the GEC data are stored on a plurality of chips in the memory unit. The memory controller is to perform a decoding operation after the encoding operation. The decoding operation is to retrieve information corresponding to the encoded cache line and the LED data, decode the retrieved information using at least an outer code decoder, determine whether the retrieved information includes an error, and output the data from the cache line at the controller.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be takers in a limiting sense, and the scope of the present disclosure is defined by the appended claims. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. It should also be noted that a plurality of hardware and software based devices, as well as a plurality of different structural components may be used to implement the disclosed methods and systems.

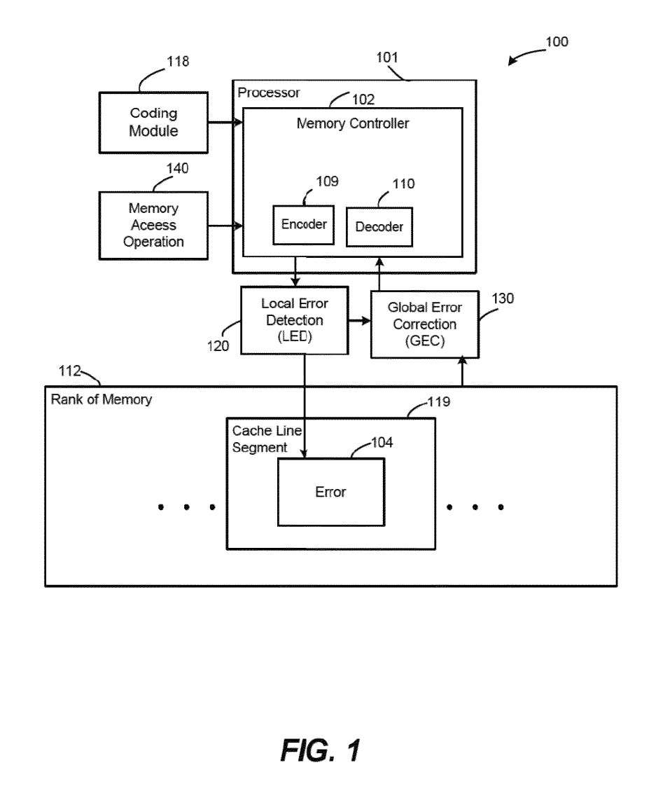

FIG. 1 is a schematic illustration of an example of a system 100 (e.g., a server system, a computer system, etc.) including a processor 101 (e.g., a central processing unit, etc.), a memory controller 102, and a coding module 118 for controlling the encoding/decoding operation of data in the memory during a memory access to enable detection and correction of random errors. The processor 101 may be implemented using any suitable type of processing system where at least one processor executes computer-readable instructions stored in a memory. In some examples, the system 100 may include more than one processor. The system 100 further includes a memory unit or module 112 (represented as a rank of a dual-in-line memory module (“DIMM”) in FIG. 1) and a system bus (e.g. a high-speed system bus, not shown). In other examples, the system 100 includes additional, fewer, or different components for carrying out similar functionality described herein.

The processor 101 and the memory controller 102 communicate with the other components of the system 100 by transmitting data, address, and control signals over the system bus. In some examples, the system bus includes a data bus, an address bus, and a control bus (not shown). Each of these buses can be of different bandwidth.

The memory controller 102 includes an encoder 109 and a decoder 110. Alternatively, the encoder 109 and the decoder 110 may be located on the memory module 112. It is to be understood that the memory controller 102 includes other components that are not shown in the figures. For example, the controller 102 may also include the following unshown components: a cache, a data selector, an address selector, buffers, control logic for scheduling request to memory units, receiving data from memory units, and forwarding the received data or other control signals to the other parts of the system.

The encoder 109 is to encode data written to the memory unit during a memory access operation with redundancy data or an error detection code to generate codewords. During a read operation, the data stored in the memory rank and the redundancy data (i.e., the codewords) is provided to the memory controller 102. The decoder 110 may be used by the memory controller 102 to decode the provided data. The controller checks the consistency of the cache line delivered from the memory unit. Thus, by using the decoded data, the memory controller determines whether an error exists in the transferred data or in one of the chips of the memory storing the data.

In some examples, the functions of the encoder 109 and the decoder 110 may be implemented through a set of instructions (e.g., via the coding module 118) and can be executed in software. The coding module 118 may be stored in any suitable configuration of volatile or non-transitory machine-readable storage media in the memory controller 102 or elsewhere on the system 100. The machine-readable storage media are considered to be an article of manufacture or part of an article of manufacture. An article of manufacture refers to a manufactured component. Software stored on the machine-readable storage media and executed by the processor may include, for example, firmware, applications, program data, filters, rules, program modules, and other executable instructions. The controller may retrieve from the machine-readable storage media and executes, among other things, instructions related to the control processes and methods described herein.

The general operation of the system is described in the following paragraphs. In response to a memory access operation 140 (e.g., read or write), the system 100 is to apply local error detection operation 120 and/or global error correction operation 130 to detect and/or correct an error 104 of a cache line segment 119 of the rank 112 of memory. In one example, system 100 is to compute local error detection (LED) information per cache line segment 119 of data. The cache line segment 119 may be associated with a rank 112 of memory. The LED information is to be computed based on an error detection code. In one example, the system 100 is to generate a global error correction (GEC) information for the cache line segment 119 (e.g., based on a global parity). The system 100 is to check data fidelity in response to memory access operation 140, based on the LED information, to identify a presence of an error 104 and the location of the error 104 among cache line segments 119 of the rank 112. The system 100 is to correct the cache line segment 119 having the error 104 based on the GEC information, in response to identifying the error 104.

In some examples, the system 103 may use simple checksums and parity operations to build a two-layer fault tolerance mechanism, at a level of granularity down to a segment 119. However, as explained in additional detail below, these simple checksums and parity operations may not be sufficient to defect all random errors in the memory and the description proposes an improved coding technique to address this issue.

In the described system, the first layer of protection may be local error detection (LED) 120, a check (e.g., an immediate check that follows a memory read operation) to verify data fidelity. The LED 120 can provide chip-level error detection (for chipkill, i.e., the ability to withstand the failure of an entire DRAM chip), by distributing LED information 120 across a plurality of chips in a memory module. Thus, the LED information 120 may be associated not only with each cache line as a whole, but with every cache line “segment,” i.e., the fraction of the line present in a single chip in the rank.

A relatively short checksum (e.g., 1's complement, Fletcher's sums, or other) may be used as the error detection code, and may be computed over the segment and appended to the data. The error detection code may be based an other types of error detection and/or error protection codes, such as cyclic redundancy check (CRC), Bose, Ray-Chaudhuri, and Hocquenghem (BCH) codes, and so on. The layer-1 protection (LED 120) may not only detect the presence of an error, but also pinpoint a location of the error, i.e., locate the chip or other location information associated with the error 104.

If the LED 120 detects an error, the second layer of protection may be applied—the Global Error Correction (GEC) 130. In some examples, the GEC 130 may be based on a parity, such as an XOR-based global parity across the data segments 119 on the data chips in the rank 112 (e.g., N such data chips). The GEC 130 also may be based on other error detection and/or error protection codes, such as CRC, BCH, and others. In some examples, the GEC results may be stored in either the same row as the data segments, or in a separate row that is to contain GEC information for several data rows. Data may be reconstructed based on reading out the fault-free segments and the GEC segment, and location information (e.g., an identification of the failed chip based on the LED).

In some examples, the LED information and GEC information may be computed over the data words in a single cache line. Thus, when a dirty line is to be written back to memory from the processor, there is no need to perform a “read-before-write,” and both codes can be computed directly, thereby avoiding impacts to write performance. Furthermore, LED information and/or GEC information may be stored in regular data memory, in view of a commodity memory system that may provide limited redundant storage for Error-Correcting Code (ECC) purposes. An additional read/write operation may be used to access this information along with the processor-requested read/write. Storing LED information in the provided storage space within each row may enable it to be read and written in tandem with the data line. In some examples, the GEC information can be stored in data memory in a separate cache line since it may only be accessed in the very rare case of an erroneous data read. Appropriate data mapping can locate this in the same row buffer as the data to increase locality and hit rates.

The memory controller 102 may provide data mapping, LED data/GEC data computation and verification (i.e., assist with encoding and decoding of the data from the memory), GEC information storage, and perform additional reads if required, etc. Thus, system 100 may provide full functionality transparently, without a need to notify and/or modify an Operating System (OS) or other computing system components. Setting apart some data memory to store LED data/GEC data may be handled through minor modifications associated with system firmware, e.g., reducing a reported amount of available memory storage to accommodate the stored LED data/GEC data transparently from the OS and application perspective.

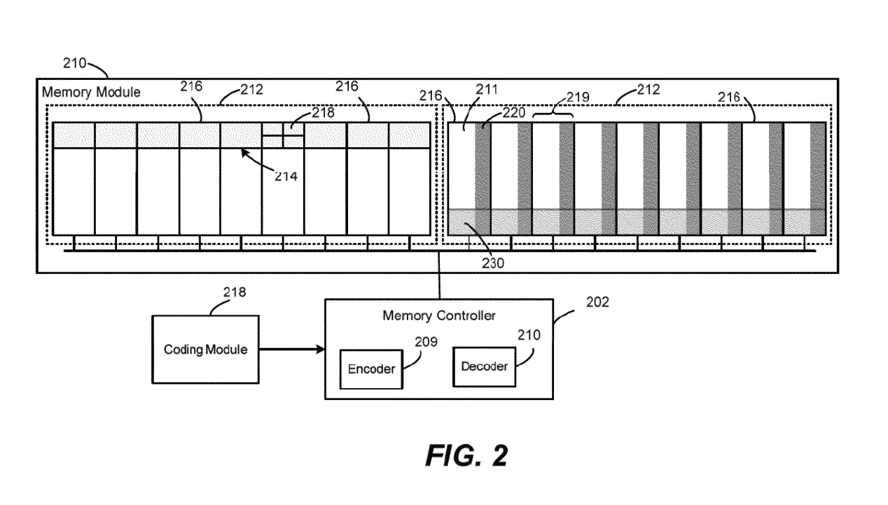

FIG. 2 is a schematic representation of an example of a memory module 210. The memory module 210 may interface with memory controller 202 and can send data, LED information, and GEC information to the memory controller 202. In one example, the memory module 210 may be a Joint Electron Devices Engineering Council (JEDEC)-style double data rate (DDRx, where x=1, 2, 3, . . . ) memory module, such as a Synchronous Dynamic Random Access Memory (SDRAM) configured as a dual in-line memory module (DIMM). Each DIMM may include at least one rank 212, and a rank 212 may include a plurality of DRAM chips 218. Two ranks 212 are shown in FIG. 2, each rank 212 including nine chips 218. A rank 212 may be divided into multiple banks 214, each bank distributed across the chips 216 in a rank 212. Although one bank 214 is shown spanning the chips in the rank, a rank may be divided into, e.g., 4-16 banks. Each bank 214 may be processing a different memory request. The portion of each rank 212/bank 214 in a chip 216 is a segment or a sub-bank 218. When the memory controller 202 issues a request for a cache line, the chips 216 in the rank 212 are activated and each segment 219 contributes a portion of the requested cache line. Thus, a cache line is striped across multiple chips 216.

In an example having a data bus width of 64 bits, and a cache line of 64 bytes, the cache line transfer can be realized based on a burst of 8 data transfers. A chip may be an xN part, e.g., x4, x8, x16, x32, etc. This represents an intrinsic word size of each chip 216, which corresponds to the number of data I/O pins on the chip. Thus, an xN chip has a word size of N, where N refers to the number of bits going in/out of the chip on each clock tick. Each segment 219 of a bank 214 may be partitioned into N arrays 218 (four are shown). Each array 218 can contribute a single bit to the N-bit transfer on the data I/O pins for that chip 216. An array 218 has several rows and columns of single-bit DRAM cells.

In one example, each chip 216 may be used to store data 211, LED information about 220, and GEC information about 230. Accordingly, each chip 218 may contain a segment 219 of data 211, LED information 220, and GEC information 230. This can provide robust chipkill protection, because each chip can include the data 211, LED data 220, and GEC data 230 for purposes of identifying and correcting errors.

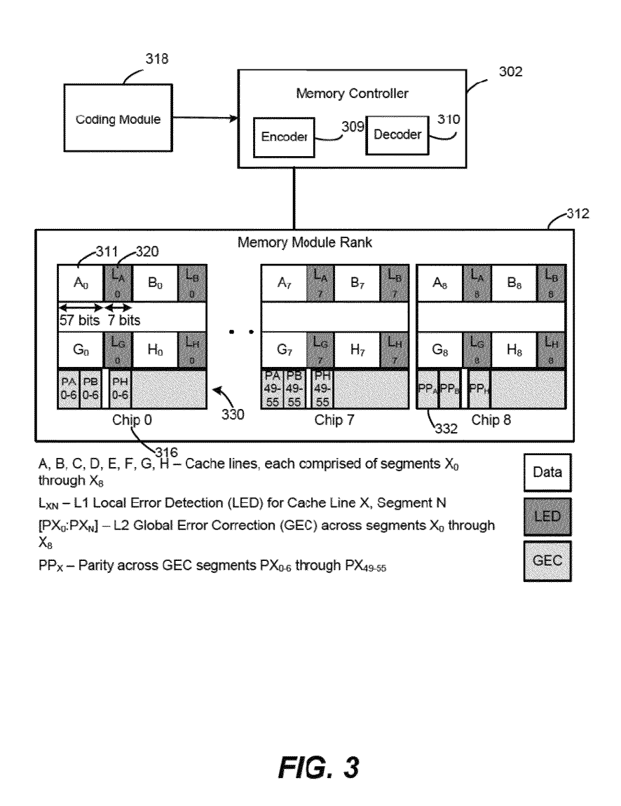

FIG. 3 is a schematic illustration showing an example of a memory module rank 312. In one example, the rank 312 may include N chips, e.g., nine x8 DRAM chips 316 (chip 0 . . . chip 8), and a burst length of 8. In alternate examples, other numbers/combinations of N chips may be used, at various levels of xN and burst lengths. The data 311, LED data 320, and GEC data 330 can be distributed throughout the chips 316 of the rank 312. The rank 312 includes a plurality of adjacent cache lines A-H each comprised of segments X₀-X₈, where the data 311, LED data 320, and GEC data 330 are distributed on the chips 316 for each of the adjacent cache lines.

In one example, LED data 320 can be used to perform an immediate check following every memory access operation (e.g., read operation) to verify data fidelity. Additionally, LED data 320 can be used to identify a location of the failure, at a chip-granularity within rank 312. As noted above, to ensure such chip-level detection (required for chipkill), the LED data 320 can be maintained at the chip level (i.e., at every cache line “segment,” the fraction of the line present in a single chip 316 in the rank 312). Cache line A may be divided into segments A0 through A8, with the associated local error detection codes LA0 through LA8.

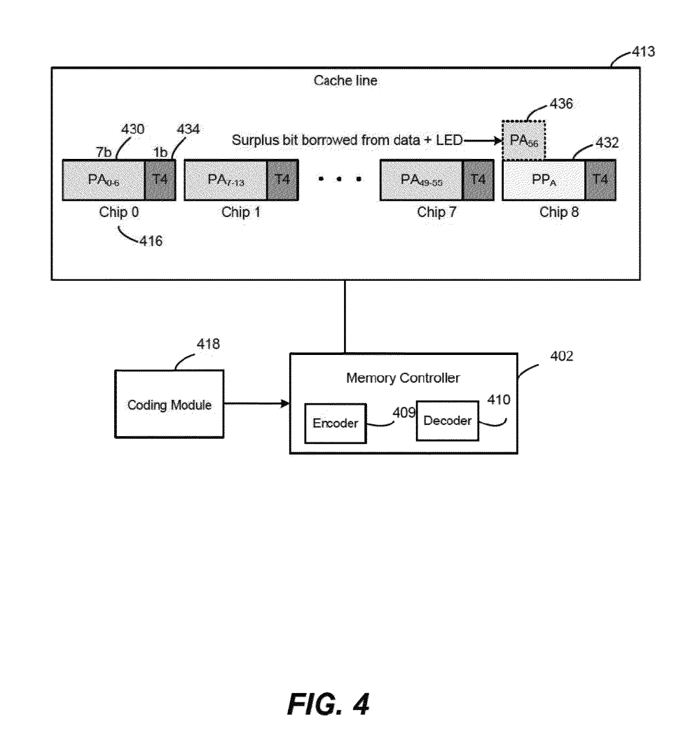

Each cache line in the rank 312 may be associated with 84 bytes of data, or 512 data bits, associated with a data operation, such as a memory access request. Because 512 data bits (one cache line) in total are needed, each chip is to provide 57 bits towards the cache line. For example, an x8 chip with a burst length of 8 supplies 64 bits per access, which are interpreted as 57 bits of data (A0 in FIG. 3, for example), and 7 bits of LED information 320 associated with those 57 bits (LA0). The proposed coding mechanism for computing the LED data is described in additional detail below. A physical data mapping policy may be used to ensure that LED bits 320 and the data segments 311 they protect are located on the same chip 316. One bit of memory appears to remain unused for every 578 bits, since 57 bits of data multiplied by 9 chips is 513 bits, and only 512 bits are needed to store the cache line. However, this “surplus bit” is used as part of the second layer of protection (e.g., GEC), details of which are described in reference to FIG. 4.

The choice of error correction code for the data 311 and the LED data 320 can depend on an expected failure mode and the specifications of the system. In some examples, a systematic error correction code may be used, where the input data from the cache line is embedded in the encoded output (i.e., a portion of the encoded word is obtained by copying the data 311). Alternatively, a non-systematic code may also be used, where the encoded output does not directly copy the input data 311.

The GEC data 330, also referred to as a Layer 2 Global Error Correction code, is to aid In the recovery of lost data once the LED data 320 (Layer 1 code) defects an error and indicates a location of the error The GEC code 330 may be a 57-bit entity, and may be provided as a column-wise XOR parity of nine cache line segments, each a 57-bit field from the data region. For cache line A, for example, its GEC data 330 may be a parity, such as a parity PA that is a XOR of data segments A0, A1, . . . A8. Data reconstruction from the GEC 330 code may be a non-resource intensive operation (e.g., an XOR of the error-free segments and the GEC 330 code), as the erroneous chip 316 can be flagged by the LED data 320.

Because there isn't a need for an additional dedicated ECC chip (what is normally used as an ECC chip on a memory module rank 312 is instead used to store data+LED 320), the GEC code may be stored in data memory itself, in contrast to using a dedicated ECC chip. The available memory may be made to appear smaller than it physically is from the perspective of the operating system, via firmware modifications or other techniques. The memory controller also may be aware of the changes to accommodate the LED data 320 and/or GEC data 330, and may map data accordingly (such as mapping to make the LED data 320 and/or GEC data 330 transparent to the OS, applications, etc.).

In order to provide strong fault-tolerance of one dead chip 316 in nine for chipkill, and to minimize the number of chips 316 touched on each access, the GEC code 330 may be placed in the same rank as its corresponding cache line. A specially-reserved region (lightly shaded GEC data 330 in FIG. 3) in each of the nine chips 316 in the rank 312 may be set aside for this purpose. The specially-reserved region may be a subset of cache lines in every DRAM page (row), although it is shown as a distinct set of rows in FIG. 3 for clarity. This co-location may ensure that any reads or writes to the GEC 330 information produces a row-buffer hit when made in conjunction with the read or write to the actual data cache line, thus reducing any potential impacts to performance.

FIG. 4 is a schematic illustration showing an example of cache line 413 including a surplus bit 436. As noted above each rank may include a plurality of adjacent cache lines, where each of the chips in the rank includes GEC information. In one example, the GEC information 430 may be laid out in a reserved region across N chips (e.g., Chip 0 . . . 8), for example as cache line A, also illustrated in FIG. 3. The cache line 413 also may include parity 432, tiered parity 434, and surplus bit 436. The adjacent cache lines (not shown) in the rank also have a similar configuration of the GEC information.

Similar to the data bits as shown in FIG. 3, the 57-bit GEC data 430 may be distributed among all N (i.e., nine) chips 419 in the rank. For example, the first seven bits of the PA field (PA0-6) may be stored in the first chip 416 (Chip 0), the next seven bits (PA7-13) may be stored in the second chip (Chip 1), and so on. Bits PA49-55 may be stored on the eighth chip (Chip 7). The last bit, PA56 may be stored on the ninth chip (Chip 8), in the surplus bit 436. The surplus bit 436 may be borrowed from the Data+LED region of the Nth chip (Chip 8), as set forth above regarding using only 512 bits of the available 513 bits (57 bits×9 chips) to store the cache line.

The failure of a chip 416 also results in the loss of the corresponding bits in the GEC 430 information stored in that chip. The GEC code 430 PA itself, therefore, is protected by an additional parity 432, also referred to as the third tier PP_{A}. PP_{A} in the illustrated example is a 7-bit field, and is the XOR of the N-1 other 7-bit fields, PA0-8, PA7-13, . . . , PA49-55. The parity 432 (PP_{A}field) is shown stored on the Nth (ninth) chip (Chip 8). If an entire chip 416 fails, the GEC 430 is first recovered using the parity 432 combined with uncorrupted GEC segments from the other chips. The chips 416 that are uncorrupted may be determined based on the LED, which can include an indication of an error's location. The full GEC 430 is then used to reconstruct the original data in the cache line.

The tiered parity 434 or the remaining 9 bits of the nine chips 416 (marked T4, for Tier-4, in FIG. 4) may be used to build an error detection code across GEC bits PA₀ through PA55, and PP_{A} in some situations. One example is a scenario where there are two errors present in the bank of chips (e.g., one of the chips has completely failed and there is an error in the GEC information in another chip). Note that neither exact error location information nor correction capabilities are required at this stage, because the reliability target is only to detect a second error, and not necessarily correct it. A code, therefore, may be built using various permutations of bits from the different chips to form each of the T4 bits 434.

Therefore, in the above-described example implementation, for each memory access operation involving a 64-byte (512-bit) cache line in a rank with nine x8 chips, the following bits may be used: 63 bits of LED information, at 7 bits per chip; 57 bits of GEC parity, spread across the nine chips; 7 bits of third-tier panty, PP_{X}; and 9 bits of T4 protection, 1 bit per chip. As noted above, the memory in system 100 includes fewer chips (e.g., nine) as compared to a conventional memory system. Data, LED, and GEC corresponding to one cache line is spread across all the chips in the rank. It is to be understood that the described system may include other implementations of the memory unit (e.g., nine x16 chips and a burst length of four, etc.).

The reduced number of chips in the described implementation increases the total bits stored per chip for a single cache line. Consequently, more redundancy on each chip is needed to protect the data in case of chip failure because the failure affects more bits. The required additional redundancy per chip must correspond to the specific data access granularities and the burst rate described above.

Further, the implementation described above proposes using simple parity and checksum to detect and recover from failures. In that situation, not all failures in the memory may be detected. Using checksum/parity cannot guarantee detection of any random set of failures across the data stored in all chips of the rank. It is possible that one in 2̂n failures may go undetected, where “n” is the number of LED or parity bits in a single chip of the memory rank. Thus, in the above-described example that includes nine x8 DRAM chips and each chip provides 57 bits of data and 7 bits of LED, one in 128 errors is not going to be detected.

Therefore, in memory devices where random errors are likely, simple checksum is not sufficient to guarantee error free operations. While in DRAM most errors manifest as stuck-at-fault—an entire row or a column or a single bit may get stuck to either zero or one, and checksum is sufficient to catch these errors, switching to NVRAM creates new sources of errors and can result in silent data corruption. For example, PCRAM cells tend to drift over time and the rate of drift can vary depending on the process variation, resulting in random errors in a cache line.

Therefore, the systems, methods, and computer readable media described herein propose using a novel coding approach for data stored on a memory unit during a memory access operation. The proposed coding approach guarantees detection and correction of random errors in a chip and reduces the number of undetected errors to one in 2̂32 (as compared to one in 2̂7 in checksum based x8 DIMMs). In one example, the proposed coding approach may include concatenated error correction coding. In other examples, other coding approaches may be applicable.

Error correction codes protect data against errors during a memory access operation. In most cases, the data subject to the memory access operation is encoded using an error-correcting code prior to storage. The additional information (i.e., redundancy) added by the code is used by the memory controller to recover the original data. It is understood that the present invention is applicable to both systematic encoders that copy the data into part of the codeword during encoding and storage, as well as to non-systematic encoders that do not copy the data into the codeword during encoding. Any one of a number of different codes may be used.

A code generally includes a set of symbol vectors all of the same length (e.g., 4 bits, 1 byte, 4 bytes, etc.). These symbol vectors that belong to a code are called codewords. In one example, a known way of describing an error correction code is to show its parity check matrix. This parity check matrix identifies precisely which vectors are valid codewords of the code.

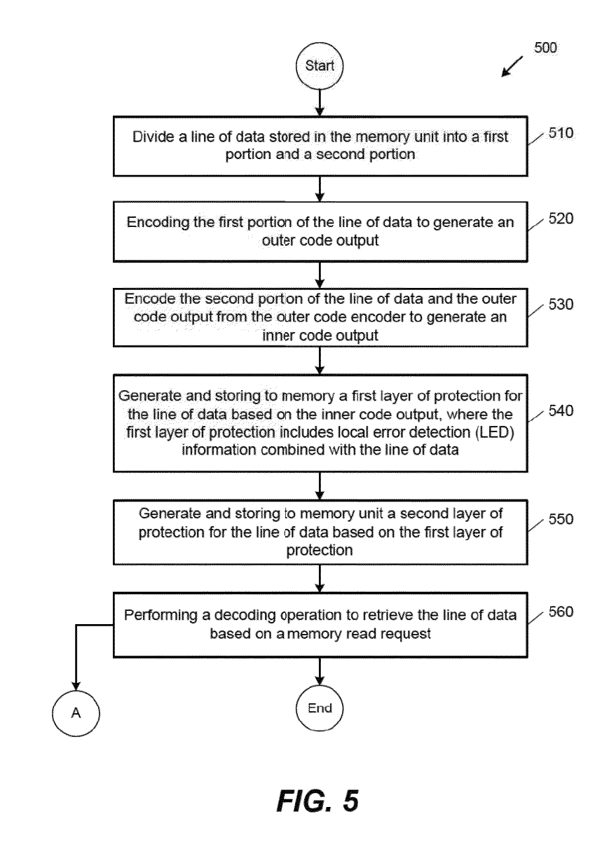

FIG. 5 illustrates a flow chart showing an example of a method 500 for operating a memory unit (e.g., the memory module 112, 210, etc.) during a memory access operation. In one example, the method 500 can be executed by the memory controller 102 of the processor 101. In other example, the method 500 can be executed by a control unit of another processor (not shown) of the system. Various steps described herein with respect to the method 500 are capable of being executed simultaneously, in parallel, or in an order that differs from the illustrated serial manner of execution. The method 500 is also capable of being executed using additional or fewer steps than are shown in the illustrated examples. The method 500 may be executed in the form of instructions encoded on a non-transitory machine-readable storage medium executable by a processor 101. In one example, the instructions for the method 500 are stored in the coding module.

The method 500 begins at step 510, where the memory controller divides a line of data stored in the memory unit into a first portion and a second portion. This step is also identified as the beginning of an encoding operation by the system and is based on a first memory access request (e.g., memory write). As mentioned above, in one example, each cache line in the memory unit is 64 bytes. Thus, at step 510, a cache line may be divided to a first portion including 28 bytes and a second portion including 36 bytes.

Next, at step 520, the controller encodes the first portion of the line of data using an outer code encoder to generate an outer code output. In one example, the outer code used by the outer code encoder is a (9, 7, 3) code. In other words, the outer code includes codewords of nine symbols with each symbol being four bytes, the code encodes seven symbols of input data, and the codewords have a minimum distance of three symbols (i.e., any two codewords in the code may differ in at least that many symbols). Thus, the outer code can correct up to one symbol error (i.e., a four byte error). In one example, the outer code encoder uses a standard coding technique (e.g., a Reed-Solomon code, etc.) to encode the first portion of the cache line. The 28 bytes of data are encoded with this (9, 7, 3) outer code to generate an outer code output of a sequence or codeword of nine four byte symbols C′₁C′₁ . . . C′₈. These symbols may then be interpreted as specifying the parity checks with respect to the inner code that a sequence of nine words, each eight bytes in length, must satisfy. Therefore, in this situation, the outer code encoder generates two bytes of redundancy.

Then, the controller encodes (e.g., by using an inner code encoder) the second portion (i.e., 36 bytes) of the line of data and the outer code output from the outer code encoder to generate an inner code output (at step 530). In one example, the inner code used by the inner code encoder is a (8, 4, 5) code. In other words, the inner code includes codewords of eight symbols, each symbol being one byte, the code encodes four symbols (i.e., 4 bytes) of input data, and the codewords have a minimum distance of five symbols. Therefore, all error patterns confined to four bytes can be detected by the inner code and beyond that only a fraction of ½³² of error patterns may not be detected.

In one example, the second portion of the cache line (i.e., 36 bytes of data) is first split into nine groups of 4 bytes. Each or the nine groups of 4 bytes is encoded using the inner code encoder followed by an adjustment so that the parity check of the i-th encoded word (of length 8B) generated from the inner code encoder equals C′₁. Therefore, encoding the second portion of the line of data and the outer code output is based on the outer code output (i.e., C′₁). In one implementation, the inner code encoder is a coset encoder. Thus, the inner code encoder may perform coset encoding to encode the second portion of the line of data and the outer code output.

The inner code may be defined in terms of a parity check matrix (e.g., a matrix over a finite field or over a binary field), which may specify what is a valid codeword by requiring that a product of that matrix with a codeword is equal to zero. The coset encoder creates a coset of the original code by shifting the original code by a vector. Thus, the product of the parity check matrix with a codeword is now equal to some other value and not to zero. The coset that is chosen is determined by C′ᵢ and which particular word in that coset is determined by the input four byte symbol from the outer code encoder. As a result, the inner code output from the inner code encoder includes nine encoded words C₀C₁ . . . C₈, where each of the codewords has eight symbols of one byte. The nine codewords include the coded line of data and the LED data (i.e., redundancy) that is later used to determine an error in the data and in the chips of the memory.

With continued reference to FIG. 5, the controller generates and stores to the memory unit a first layer of protection for the line of data based on the inner code output (at step 540). The first layer of protection includes the line of data (i.e., 64 bytes) combined with the generated local error detection (LED) information for that cache line. In other words, the nine encoded words C₀C₁ . . . C₈ generated from the inner code encoder include the first layer of protection for the line of data. Each of the nine chips of the rank stores a portion of the codewords. For example, each chip may store a single codeword including data from the cache line and LED data. The nine encoded words corresponding to the nine columns of the first protection layer may be stored on distinct chips.

Next, at step 550, the controller generates and stores in the memory unit a second layer of protection for the line of data based on the first layer of protection. The second layer of protection includes global error correction (GEC) information generated from the first layer of protection. As noted earlier, for a memory read, the first layer of protection is sent to the controller based on a first memory access operation (e.g., memory read), and the second layer of protection is sent to the controller based on a second memory access operation (e.g., when the LED detects an error and the GEC data is needed to remedy the error).

The second layer of protection (i.e., the GEC data) is generated based on the first layer of protection (cache line plus LED data for the cache line). In one example, the GEC data is obtained by computing a parity byte for each (byte-wise) row of the first layer of protection resulting in eight parity bytes P₀, P₁, . . . , P₇ of GEC. Another parity byte P₈ of GEC is, in turn, computed from the first eight GEC parity bytes P₀ . . . P₇. The resulting nine bytes of GEC P₀,P₁, . . . , P₈ constitute nine bytes of the GEC row, with one byte corresponding to (and stored on the same chip as) each respective column of the first layer of protection.

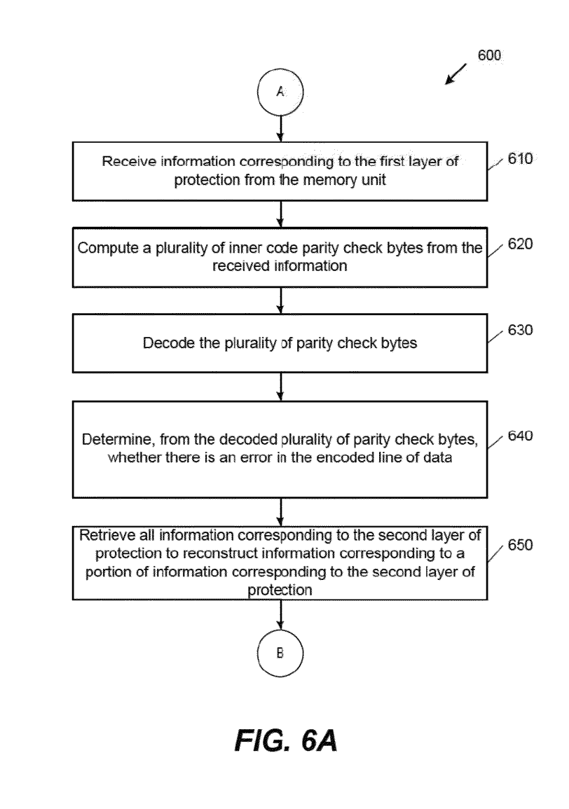

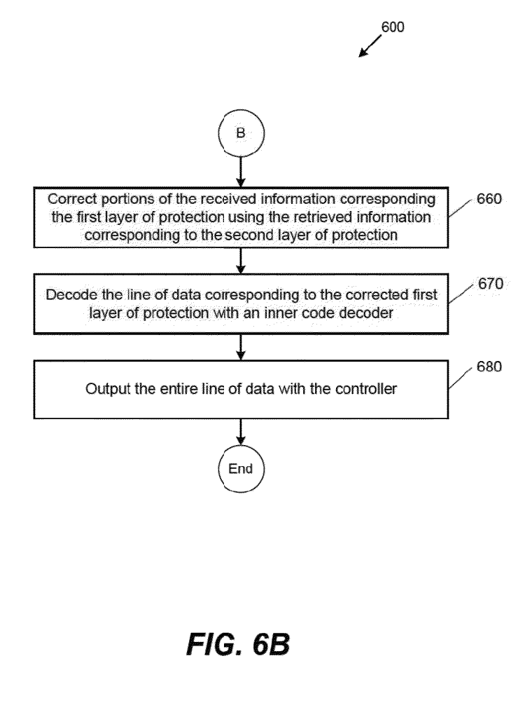

At step 560, the system performs a decoding operation to retrieve the line of data at the controller based on a memory read request. It is to be understood that the decoding operation may not automatically fellow the encoding of the data but may be based in a subsequent read request from the memory controller. After the data in the cache line is requested, the first layer of projection (including the data from the cache line) is sent to the memory controller for decoding. The decoding operation is described in more details with respect to the method 600 illustrated in FIGS. 6A and 6B.

The inner code encoder and the outer code encoder may be systematic encoders or non-systematic encoders. When these encoders are systematic, the input data from the line of data is embedded in the encoded input without being manipulated by the encoders. On the other hand, when these encoders are non-systematic, the input data from the line of data is manipulated prior to encoding and storage by the encoders. As explained in additional details below, the decoding operation performed by the system may vary depending on whether the inner code encoder and the outer code encoder are systematic encoders or non-systematic encoders.

In one example, when the inner and outer code encoders are systematic codes, a portion of the encoded word is obtained by simply copying the input bytes from the line of data. In this case, the first seven columns of the first layer of protection and the first four bytes of the last two columns may be obtained by directly copying the 64 input bytes from the cache line. The last four bytes of each of the last two columns are obtained by computing and adjusting the parities of the inner code (e.g., using standard methodology) so that the overall parity checks of these words evaluate to the last two components of the outer codeword (e.g., C′₇ and C′₈).

FIGS. 6A and 6B illustrate a flow chart showing an example of a method for decoding data received from a memory unit. In other words, the controller performs a decoding operation to retrieve the line of data at the controller. In one example, the method 600 can be executed by the memory controller 102 of the processor 101. Various steps described herein with respect to the method 600 are capable of being executed simultaneously, in parallel, or in an order that differs from the illustrated serial manner of execution. The method 600 is also capable of being executed using additional or fewer steps than are shown in the illustrated examples. The method 600 may be executed in the form of instructions encoded on a non-transitory machine-readable storage medium executable by a processor 101. In one example, the instructions for the method 600 are stored in the coding module.

The method 600 begins at step 610, where the controller receives information corresponding to the first layer of protection from the memory unit. In other words, based on a read request, the controller receives nine possibly corrupted columns (e.g., denoted by D₀D₁ . . . D₈) that correspond to the first layer of protection and include the encoded cache line data (which is possibly erroneous) and the generated LED data associated with the cache line data. As explained in additional detail below, the controller may also receive possibly corrupted GEC data (e.g., denoted by Q₀Q₁ . . . Q₈). The bytes of GEC data are only needed if an error is detected in the first layer protection received at the controller.

Next, at step 620, the controller computes a plurality of inner code parity check bytes from the received information. In one example, the controller computes four byte parity checks of each of the columns D₀D₁ . . . D₈ with respect to the inner code to obtain nine Inner code parity check symbols, each four bytes in size (e.g., denoted by D′₀D′₁ . . . D′₈). At step 630, the controller decades (e.g., with an outer code decoder) the plurality of parity check bytes or symbols. It is to be understood that the terms parity bytes and parity symbols may be used interchangeable for purposes of describing the decoding operation, (i.e., the groups of four bytes are treated as symbols in the larger alphabet-size (e.g. four byte) code). Decoding the nine parity check symbols with the outer code decoder generates a corrected sequence of four byte parity check bytes (i.e., a codeword). The generated codeword may be denoted by C′0C′1 . . . C′8.

The controller then uses the decoded plurality of parity check bytes to determine whether there is an error in the encoded line of data (at step 640). For example, the controller compares the sequences D′₀D′₁ . . . D′₈ and C′₀C′₁ . . . C′₈. (i.e., the inner code parity check bytes with the codeword corresponding to the corrected sequence of parity check bytes) to identify if there is a component index “J” in which they differ. If the nine inner code parity check bytes correspond to the codeword in the outer code codebook, there is no error in the encoded line of data. Alternatively, using other known methods, the outer decoder may compute a syndrome using the parity check matrix of the outer code and the potentially erroneous sequence D′₀D′₁ . . . D′₈ and declare no error if this syndrome is zero.

If there is no error, the 28 bytes of cache line data (i.e., the first portion of the line of data) are decoded. Only 28 bytes of cache line data are decoded at this point if the code used by the system is non-systematic. If, however, there is no error and the code that is used is a systematic code, the full 64 bytes of cache line data can be read off the corresponding portion of D₀D₁ . . . D₈ (i.e., the possibly corrupted columns that correspond to the first layer of protection, which were received at step 610). That is possible, because the systematic code simply copies the data from the cache line to the codewords. In that situation, the controller nay not need to operate an inner code decoder to decode the inner code data and the entire line of data may be outputted at the controller based on the decoding performed by the outer code decoder.

On the other hand, it one of the nine inner code parity check bytes does not correspond to the corrected sequence of parity check bytes, the controller determines that there is an error in the encoded data. The controller may also identify the specific chip (i.e., a column) associated with the error based on an address index “J” of the symbol in which the sequences D′₀D′₁ . . . D′₈ and C′₀C′₁ . . . C′₈ differ (i.e., J=min j s.t. C′ⱼ≠D′ⱼ).

With continued reference to FIGS. 6A and 6B, when the controller determines that there is an error in the encoded data, the controller retrieves all information corresponding to the second layer of protection (i.e., GEC data) to reconstruct a portion of information corresponding to the second layer of protection (at step 650). Since in step 640 the controller identified that there was an error in the coded data and pointed to a column corresponding to a specific chip, it is possible that the GEC data corresponding with that chip is also erroneous. In other words, an erroneous column “J” may indicate an unreliable J-th component of the GEC row since these are both stored on the same chip. Therefore, the controller uses the bytes of retrieved GEC data from the memory to compute a parity and to correct the GEC data corresponding with the failed chip (i.e., the GEC byte for the chip identified at step 640). Thus, the J-th component of the GEC (denoted by Q_{J}) is corrected to Σ_{i≠j}Qᵢ which denotes the byte parity of all of the other bytes of the GEC word excepting the J-th byte. Assuming an error only in Q_{J}, this operation together with the fact that P₈, the uncorrupted version of Q₈ was set to the byte parity of the original GEC row parity bytes P₀ . . . P₇ obtained during encoding, implies that after this operation Q₀ . . . Q₇=P₀ . . . P₇.

Next, at step 660, the controller corrects portions of the received information corresponding the first layer of protection using the retrieved information corresponding to the corrected second layer of protection. In other words, the controller uses the available parity of the LED data across all the chips (i.e., the corrected GEC data) together with the received cache line data from all the chips to reconstruct the retrieved data corresponding to the failed chip (which includes portions of the encoded cache line and LED data). For example, the J-th column D_{J} of the data (corresponding to the data+GEC information form the failed chip) is corrected to [Q₀Q₁ . . . Q₇]+Σ_{j≠J}Dᵢ, the row-wise parity sum of the corrected parity check column and the other, presumably correct, columns.

The controller then decodes the line of data corresponding to the corrected first layer of protection with an inner code decoder (at step 670). Thus, by using the inner code decoder, the controller obtains the 36 bytes of data from the cache line. The 36 bytes of data from the cache line are then combined with the 28 bytes of cache line data obtained via the application of the outer code decoder. The controller then outputs the entire line of data (at step 680). If the system used a systematic code, all 64 bytes of data can be copied directly from the systematic portion of the corrected cache line and LED data.

This above-described coding approach generates sufficient redundancy data to guarantee detection of a larger number of random error patterns in a chip. In one example, the coding approach reduces the number of undetected errors to one in 2̂32 (as compared to one in 2̂7 in checksum based x8 DIMMs). This is due to the fact that the coding approach requires accessing all the chips in the rank for local error detection. All the chips in the rank must be checked as a unit and not independently of one another, which may reduce parallelism but increases the probability of detecting random errors.

The decoder may correct any single column error (i.e., an error in a single rank) in which any four bytes are in error. A single column error may result in erroneous decoding only if the error is such that it fails to affect the parity check of the inner code. As noted however, this would be the case for only ½³² fraction of all error patterns. Thus, the proposed coding approach reduces the fraction of single column error patterns that result in a reduced decoder failure and provide a greater reliability assurance in some applications.

1. A method of operating a memory unit during a memory access operation, the memory unit including a configuration of N data chips, the method comprising:
dividing, with a controller, a line of data stored in the memory unit into a first portion and a second portion;
encoding, with an outer code encoder, the first portion of the line of data to generate an outer code output;
encoding, with an inner code encoder, the second portion of the line of data and the outer code output from the outer code encoder to generate an inner code output;
generating and storing to the memory unit, with the controller, a first layer of protection for the line of data based on the inner code output, where the first layer of protection includes local error detection (LED) information combined with the line of data;
generating and storing to the memory unit, with the controller, a second layer of protection for the line of data based on the first layer of protection; and
performing, at the controller, a decoding operation to retrieve the line of data based on a memory read request.

2. The method of claim 1, wherein the decoding operation further comprises
receiving, at the controller, information corresponding to the first layer of protection from the memory unit;
computing, with the controller, a plurality of inner code parity check bytes from the received information;
decoding, with an outer code decoder, the plurality of parity check bytes;
determining, with the controller from the decoded plurality of parity check bytes, whether there is an error in the encoded line of data;
retrieving, with the controller, all information corresponding to the second layer of protection to reconstruct a portion of information corresponding to the second layer of protection;
correcting portions of the received information corresponding to the first layer of protection using the retrieved information corresponding to the second layer of protection;
decoding, with an inner code decoder, the line of data corresponding to the corrected first layer of protection; and
outputting, with the controller, the entire line of data.

3. The method of claim 2, wherein the first layer of protection is sent to the controller based on a first memory access operation, and wherein the second layer of protection includes global error correction (GEC) information that is sent to the controller based on a second memory access operation.

4. The method of claim 1, wherein the line of data includes 64 bytes, the first portion of the line of data includes 28 bytes, and the second portion of the line of data includes 36 bytes.

5. The method of claim 1, wherein an outer code used by the outer code encoder includes codewords of nine symbols, each symbol being four bytes, and the codewords have a minimum distance of three symbols, and wherein an inner code used by the inner code encoder includes codewords of eight symbols, each symbol being one byte, and the codewords have a minimum distance of five symbols.

6. The method of claims 1, wherein encoding the second portion of the line of data and the outer code output is based on the outer code output, and wherein the inner code output includes nine codewords of eight symbols each having one byte, the nine codewords including the first layer of protection.

7. The method of claim 6, wherein the memory unit includes nine x8 data chips and a burst length of eight, and wherein each chip stores a portion of the codewords generated by the inner code output.

8. A system for operating a memory unit, the system comprising:
a processor having a memory controller in communication with the memory unit, the memory controller to:
perform an encoding operation based on a first memory access request, the encoding operation to:
generate an outer code output using an outer code encoder of the controller to encode a first portion of a cache line,
generate an inner code output using an inner code encoder of the controller to encode a second portion of the cache line and the outer code output,
generate local error deletion (LED) data for the cache line based on the inner code output, and
generate global error correction (GEC) data for the cache line based on the LED data, where the LED data and the GEC data are stored on a plurality of chips in the memory unit; and
perform a decoding operation after the encoding operation, the decoding operation to;
retrieve information corresponding to the encoded cache line and the LED data,
decode the retrieved information using at least an outer code decoder,
determine whether the retrieved information includes an error, and
output the data from the cache line at the controller.

9. The system of claim 8, wherein the memory controller is to:
compute a plurality of inner code parity check bytes for the information corresponding to the encoded cache line and the LED data,
decode the plurality of parity check bytes using the outer code decoder to determine if there is an error and a failed chip in the memory unit,
retrieve GEC data from the plurality of chips of the memory unit to reconstruct GEC data on the failed chip when an error is detected, and
use the GEC data to reconstruct portions of the encoded cache line and LED data on the failed chip.

10. The system of claim 8, wherein the cache includes 64 bytes, the first portion of the line of data includes 28 bytes, and the second portion of the line of data includes 36 bytes, and wherein the memory unit includes nine x8 data chips and a burst length of eight.

11. The method of claim 8, wherein an outer code used by the outer code encoder includes codewords of nine symbols, each symbol having four bytes, and the codewords have a minimum distance of three symbols, and wherein an inner code used by the inner code encoder includes codewords of eight symbols, each symbol having one byte, and the codewords have a minimum distance of five symbols.

12. The system of claim 1 wherein the outer code encoder and the inner code encoder are systematic encoders.

13. A non-transitory machine-readable storage medium encoded with instructions executable by a processor in a memory system, the machine-readable storage medium comprising instructions to:
divide a cache line stored in a memory unit including a plurality of chips into a first portion and a second portion;
encode the first portion of the cache line to generate an outer code output;
encode the second portion of the cache line and the outer code output to generate an inner code output;
generate local error detection (LED) data for the cache line based on the inner code output, where the LED data is combined with the cache line to define a first layer of protection;
generate global error correction (GEC) data for the cache line based on the LED data, where the LED data, the GEC data, and the cache line are distributed among the plurality of chips in the memory unit;
retrieve Information corresponding to the first layer of protection from the memory unit;
decode at least the data corresponding to the outer code output of the distributed LED data and the cache line; and
output the data from the cache line at the controller.

14. The non-transitory machine-readable storage medium of claim 13, further comprising instructions to
compute a plurality of inner code parity check bytes,
decode the plurality of parity check bytes to determine if there is an error and a failed chip in the memory unit,
reconstruct GEC data on a failed chip when an error is detected using GEC data from the plurality of chips of the memory unit,
reconstruct the first layer of protection and the parity check bytes on the failed chip using the reconstructed GEC data, and
decode the reconstructed parity check bytes using the outer code output.

15. The non-transitory machine-readable storage medium of claim 13, wherein encoding the second portion of the cache line and the outer code output is based on the outer code output, and wherein the inner code output includes nine codewords of eight symbols, each having one byte, the nine codewords comprising the first layer of protection.
